(19) United States
(12) Patent Application Publication
(10) Pub. No.: US 2022/0397169 A1
(43) Pub. Date: Dec. 15, 2022

(54) BRAKE DUST PARTICLE FILTER WITH WATER/SLUDGE DRAIN

(71) Applicant: MANN+HUMMEL GMBH, Ludwigsburg (DE)

(72) Inventors: Volker KUEMMERLING, Bietigheim-Bissingen (DE); Lukas BOCK, Bietigheim-Bissingen (DE); Thomas JESSBERGER, Asperg (DE); Coskun EVLEKLI, Waiblingen (DE); Michael GEIGER, Freiberg (DE)

(21) Appl. No.: 17/888,420

(22) Filed: Aug. 15, 2022

Related U.S. Application Data
(63) Continuation of application No. PCT/EP2020/053857, filed on Feb. 14, 2020.

(51) Int. Cl. F16D 65/00; B60S 1/68

(52) U.S. Cl. CPC F16D 65/0031; F16D 65/0081; F16D 65/0025; B60S 1/68; F16D 2055/0037

(57) ABSTRACT

A brake dust particle filter for an assembly with a brake disc is provided with a ring section-shaped housing that at least partially surrounds the brake disc in a mounted state. The housing has a housing interior. The housing is made of a metal material. The housing interior has a lowermost point and has at the lowermost point an axially embodied drainage cutout for drainage of a fluid out of the housing interior. The housing has an outwardly positioned, mostly axially expanding guide arranged at the drainage cutout for guiding the fluid. An assembly with a brake disc and a brake caliper arranged at the brake disc is provided with such a brake dust particle filter that is arranged at least partially in a bottom region of the brake disc.

### CROSS-REFERENCE TO RELATED APPLICATIONS

This application is a continuation application of international application No. PCT/EP2020/053857 having an international filing date of 14 Feb. 2020 and designating the United States, the entire contents of the aforesaid international application being incorporated herein by reference.

### BACKGROUND OF THE INVENTION

The invention concerns a brake dust particle filter for an assembly with a brake disc and a brake caliper. Furthermore, the invention concerns an assembly with a brake disc, a brake caliper, and such a brake dust particle filter.

It is known to employ brake dust particle filters in order to catch and subsequently dispose of abraded brake particles in the form of dust particles produced during the braking process. Due to the large number of motor vehicles and the associated high brake dust emission, disc brake assemblies are often combined with such brake dust particle filters.

DE 10 2012 022 886 A1 discloses a brake dust particle filter for mounting on a cover plate of a brake disc. The brake dust particle filter is configured in this context as a ring segment and can be connected by various through passages and tabs to the cover plate. In particular, the brake dust particle filter comprises a through passage, optionally with an outlet pipe adjoining it, for venting. Through this passage, brake dust can be discharged into the environment by means of an air flow generated by the rotating wheels and cleaning of the brake disc assembly can be avoided in this way.

DE 10 2006 051 972 A1 discloses a brake dust particle filter for a disc brake. A plurality of air inlet openings and brake dust inlet openings ensure in this context cooling of the brake disc as well as catching of the brake dust. By means of a special opening, retained brake dust can be disposed of as needed.

The brake dust particle filters described in the prior art focus on catching and controlled blowing out of brake dust and neglect the problem of fluid ingress into the brake dust particle filter in this context.

In case of heavy water contact with the brake assembly, for example, when wading or driving in rain, conventional brake dust particle filters are exposed to the risk of sludge accumulation, in particular clogging of filter openings and/or of the functional openings. Incoming water washes off the retained brake dust, penetrates into the fine-pore filter medium, and clogs it. Moreover, in particular when driving off-road, an increased ingress of greatly contaminated water or even sludge may occur. In particular, sludge clogs air-guiding functional openings that, for example, are provided for cooling the brake disc or for discharging the brake dust. Current systems provide no satisfactory option of counteracting sludge accumulation or clogging, respectively, closure of the catching device by dirt or deposits as a result of introduced fluid.

### SUMMARY OF THE INVENTION

In contrast thereto, it is the object of the present invention to develop a brake dust particle filter that retains as much brake dust in the filter as possible, in addition provides a high safety against sludge accumulation and clogging of the catching device, in particular of the filter medium, while being realizable for easy servicing and at low cost and while minimizing soiling of the wheel rim, in the best case counteracting the soiling.

This object is solved by a brake dust particle filter for an assembly with a brake disc, wherein the brake dust particle filter comprises a ring section-shaped housing, at least partially surrounding the brake disc in the mounted state, with a housing interior, wherein the housing comprises or is comprised of a metal material, wherein the housing interior comprises at its lowermost point an axially embodied drainage cutout for drainage of fluid out of the housing interior, wherein the housing comprises at the drainage cutout an outwardly positioned, mostly axially expanding guide that serves for guiding the fluid.

The object is further solved by an assembly with a brake disc, a brake caliper, in particular a cover plate, and a brake dust particle filter, wherein the brake dust particle filter is a brake dust particle filter according to the invention that is arranged at least partially in a bottom region of the brake disc.

The dependent claims provide preferred further developments.

The brake dust particle filter according to the invention comprises a ring section-shaped housing, which at least partially surrounds the brake disc in the mounted state, with a housing interior, wherein the housing interior at its lowermost point comprises an axially configured drainage cutout that ensures drainage of liquids from the housing interior. The housing comprises or is comprised of a metal material. Preferably, the housing is formed of sheet metal, in particular sheet steel. By forming and welding, housings with the required flexibility in respect to shape can be produced from sheet metal. Due to their high temperature resistance, metal materials, in particular steel, are well suited because temperatures of several hundred degrees Celsius can occur in the region of disc brakes.

In this context, the term of the lowermost point also includes a position at the housing of the brake dust particle filter, in particular of the housing interior, which geometrically represents the lowermost point under the action of the force of gravity. Correspondingly, it is avoided that introduced fluid can collect in other partial areas of the housing and is prevented from draining. Relative to a radial discharge, an axial discharge of introduced fluid and/or solid bodies has additionally the advantage of claiming less installation space in radial direction of the brake disc. This installation space is constructively narrowly limited due to the adaptation of the wheel rim dimension to the brake disc dimension. Moreover, for axial configuration of the drainage cutout, the filtering action can be used on the entire radial housing circumference.

Positional and directional specifications such as “top”, “bottom”, “lowermost”, “uppermost” and the like relate to the mounted state of the brake dust particle filter or of the assembly, wherein cylinder coordinate specifications such as “radial”, “axial”, “circumferential” and the like relate to a rotational direction of the brake disc in a mounting arrangement of the brake dust particle filter.

According to the invention, introduced fluid and solid bodies, in particular introduced water, brackish water, and sludge, in the brake dust particle filter is transported through the housing interior, in particular by the housing wall, to a collecting point and subsequently guided out of the housing by means of a drainage cutout at the housing wall, in particular at a part of the housing wall that is extending parallel to and axially spaced apart from the brake disc. As a result of this, only minimal residues of the fluid or of the solid bodies remain in the brake dust particle filter. A sludge accumulation or a clogging of the brake dust particle filter or of the brake dust catching device can thus be effectively prevented thereby.

The housing comprises at the drainage cutout an outwardly positioned, primarily axially expanding guide. The guide serves for guiding the draining fluid out of the drainage cutout away from the housing of the brake dust particle filter and prevents thus dripping of the discharged liquid at the wall of the drainage cutout. An axial expansion of the guide relates in this context to an extension that extends parallel to the axis of rotation of the brake disc.

In a preferred further development of this embodiment, the guide is either embodied closed in its circumferential direction (=axial direction), in particular tubular, or open, in particular groove-like. This provides the advantage of a discharge of the fluid introduced into the brake dust particle filter which is particularly effective and adapted to the utilization purpose and the property of the introduced fluid. A necessity for the adaptation of the drainage cutout and of the guide can result from the various fields of use of motor vehicles. For example, in case of off-road vehicles, there is an increased need to discharge high-viscosity fluids, in particular sludge and/or brackish water. On the other hand, there are road vehicles, for example, where the focus is on fast and clean discharge of aqueous fluids, in particular rainwater.

In a preferred further development, the guide is inclined at the drainage cutout at an angle relative to the horizontal, respectively, to the axis of rotation of the brake disc, in particular in the direction of the force of gravity. By an incline of the guide, a drainage of the introduced fluid is improved. In this context, the incline amounts to more than 0.5°, preferably more than 5°, particularly preferred more than 8°.

Particularly preferred is a further development, in which the guide is embodied as one piece together with the housing of the brake dust particle filter. In this way, the complexity of the whole device as well as the number of the device components is reduced and thus the manufacture as well as the assembly facilitated. The invention is of course not limited to this and encompasses also an assembled, i.e., two-part, embodiment.

Alternatively or additionally, the drainage cutout can be covered at least partially, preferably completely, by a filter medium, in particular a metal grid and/or metal nonwoven. In this way, it can be prevented that brake dust particles also reach the environment together with the fluid to be discharged.

Preferred is furthermore an embodiment in which the housing of the brake dust particle filter is of a multi-part configuration. By dividing the housing into several partial components, in particular three parts or two parts that preferably enclose half of the brake disc, respectively, the fastening of the brake dust particle filter is simplified. Furthermore, the expenditure in the servicing situation, for example, when the brake dust particle filter is to be exchanged or cleaned, is reduced because a complete disassembly of the brake dust particle filter is not required.

In a preferred embodiment, the housing of the brake dust particle filter comprises an incline toward the lowermost point in the surroundings of the lowermost point at the wall of the housing interior, in particular of the housing bottom. The incline amounts in this context to more than 0.5°, preferably more than 5°, particularly preferred more than 8°. The housing bottom can comprise the same incline as the guide so that the fluid flow can be realized very uniformly. In this way, the complete drainage of the introduced fluid is guaranteed and it is ensured that no fluid residue remains in the brake dust particle filter.

Particularly advantageous is an embodiment with at least one cutout at the housing circumference of the brake dust particle filter which is covered by a filter medium. Due to this filter cutout, an air flow which is laden with brake dust particles can be filtered particularly effectively. This is based on the utilization of the centrifugal force which acts on the air flow entrained by the rotating brake disc and causes a radial, respectively, tangential flow of the particles in relation to the axis of rotation of the brake disc. The air flows in this context through the filter medium and the filter cutout while the brake dust particles remain in the filter medium.

Preferred is furthermore an embodiment in which the housing of the brake dust particle filter comprises flow-promoting recesses, in particular flow grooves at the wall of the housing interior, more precisely a wall of the housing which is facing the housing interior. Particularly advantageous is furthermore the constructive configuration of fluid-guiding elevations, in particular guide ribs, in order to guide draining fluid effectively around regions to be protected, in particular the functional openings and the filter media. Moreover, special surface coatings can be used in order to prevent the introduced fluid or the introduced solid bodies from adhering and to enable a fast discharge of the aforementioned introduced matter.

The object is furthermore solved by an assembly with a brake disc, a brake caliper, in particular a cover plate, and a brake dust particle filter herein described, wherein the brake dust particle filter is arranged in the bottom region of the brake disc. In this assembly, an optimal discharge of the fluid, introduced into the brake dust particle filter, is achieved via the housing walls into the housing interior, with subsequent drainage through the drainage cutout.

In a preferred further embodiment, the cover plate is a part of the housing of the brake dust particle filter. In this way, not only the manufacturing and mounting expenditure can be reduced but also the effective drainage of introduced fluid from the assembly can be realized. In conventional application situations, in particular without introduced fluid in the assembly, the degree of caught brake dust particles by the brake dust particle filter is also increased, which leads to a reduced load of the environment by brake dust.

In a particularly preferred embodiment of the described assembly, the assembly comprises a wheel rim and a guide for discharging fluid introduced into the assembly, in particular sludge or brackish water, and the guide extends to the inwardly positioned edge of the wheel rim in order to prevent soiling of the wheel rim by dripping fluid, in particular sludge and/or brackish water. This is particularly advantageous when the described brake dust particle filter is used in an assembly with a wheel rim with a flat rim well. Due to the flat rim well, which is characterized by a minimal incline relative to the horizontal, no shape-promoted drainage via the wheel rim occurs. As a result of this, contaminations, for example, due to dripping of sludge or brackish water, remain relatively long on the wheel rim, respectively, they do not drain off at all. By a guide with aforementioned length, these contaminations due to introduced fluid, in particular sludge or brackish water, can be effectively prevented. Alternatively or in addition, a guide of a similar configuration, but oriented in the direction of the wheel rim spokes, can be a component of the assembly. In this case, the guide due to the special orientation is provided with a cleaning function because fluid introduced into the assembly, in particular rainwater, can be deflected in a targeted fashion onto the spokes of the wheel rim in order to rinse them. Alternatively or additionally to the actual benefit, adhering contaminations at the wheel rim can thus be effectively detached.

Moreover, the size of the drainage cutout, in particular its diameter, can be adapted to the special requirements of different utilization purposes. Depending on the degree of soiling that is to be expected, respectively, the viscosity to be expected of the fluid introduced into the assembly, the drainage cutout and/or the guide can be varied in regard to the size, in particular the diameter. Advantageously, the diameter of the drainage cutout amounts to more than 0.5 cm, preferably more than 1 cm, particularly preferred more than 2 cm. This provides the advantage of preventing a clogging of the drainage cutout in the case of viscous fluids, in particular viscous liquids, or of improving the cleaning effect in case of low viscosity fluids, in particular water, due to a smaller diameter of the drainage cutout.

Further advantages of the invention result from the description and the drawing. Also, the aforementioned and still further disclosed features can be used according to the invention each individually by themselves or several combined in arbitrary combinations. The illustrated and described embodiments are not to be understood as a complete listing but have instead an exemplary character for describing the invention.

### BRIEF DESCRIPTION OF THE DRAWINGS

FIG. 1 shows a first embodiment of an assembly with a wheel rim.

FIG. 2 shows a section illustration II-II of the assembly with a wheel rim of FIG. 1.

FIG. 3 shows a plan view of a second embodiment of an assembly with a wheel rim.

FIG. 4 shows a section illustration IV-IV of the assembly with a wheel rim of FIG. 3.

FIG. 5 shows a side view of the second embodiment of the assembly of FIG. 3 without wheel rim.

FIG. 6 shows a perspective view of the second embodiment of the assembly of FIG. 3 without wheel rim.

FIG. 7 shows a side view of a further embodiment of an assembly.

### DESCRIPTION OF PREFERRED EMBODIMENTS

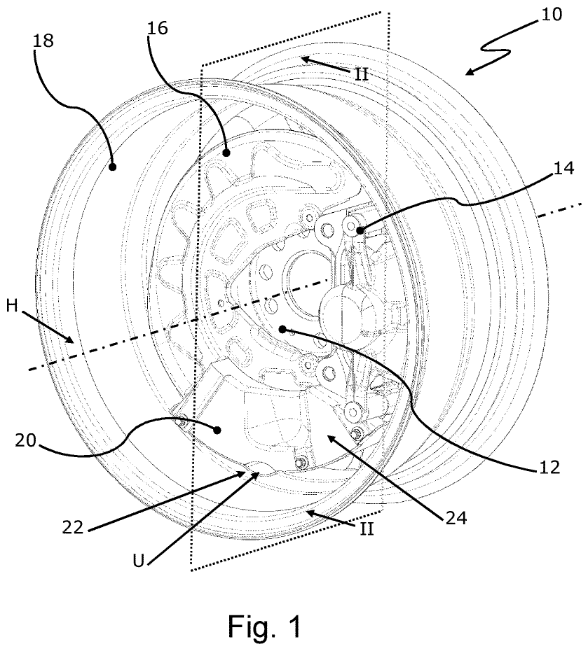

FIG. 1 shows a first embodiment of an assembly 10 with a brake disc 12, a brake caliper 14, a cover plate 16, a wheel rim 18, and a brake dust particle filter 20 which is located in the bottom region of the brake disc 12 in the mounted state. The brake dust particle filter 20 comprises at a lowermost point U a drainage cutout 22 which is arranged at a side of the housing 24 that is parallel to and spaced apart from the brake disc 12.

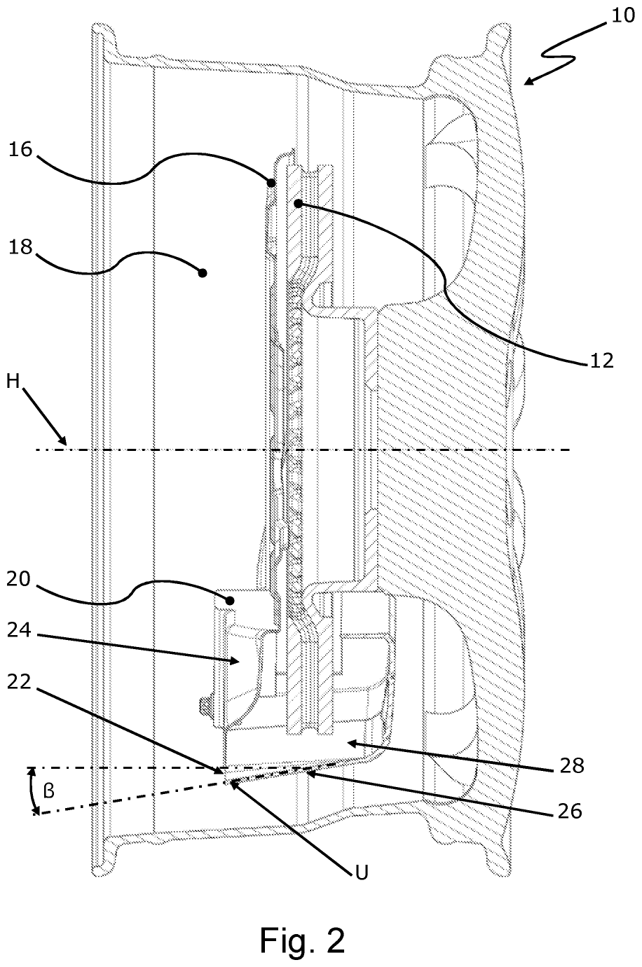

FIG. 2 shows a section illustration II-II of the assembly 10 with the wheel rim 18 of FIG. 1. The brake dust particle filter 20 comprises a housing bottom 26 at the radial circumferential side 28 of the housing 20. The housing bottom 26 comprises an incline β relative to the horizontal H toward the lowermost point U.

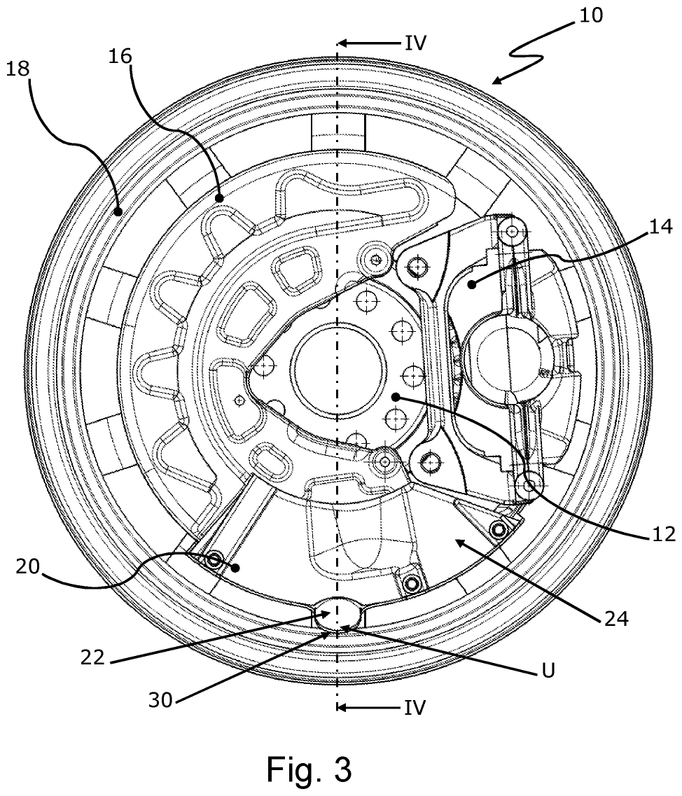

FIG. 3 shows a plan view of a second embodiment of an assembly 10 with a brake disc 12, a brake caliper 14, a cover plate 16, a wheel rim 18, and a brake dust particle filter 20. The brake dust particle filter 20 comprises a guide 30 which is arranged or embodied at the drainage cutout 22 at the lowermost point U of the housing 24. Preferably, the guide 30—as presently—can be embodied as one piece together with the housing 24 or a part of the housing 24.

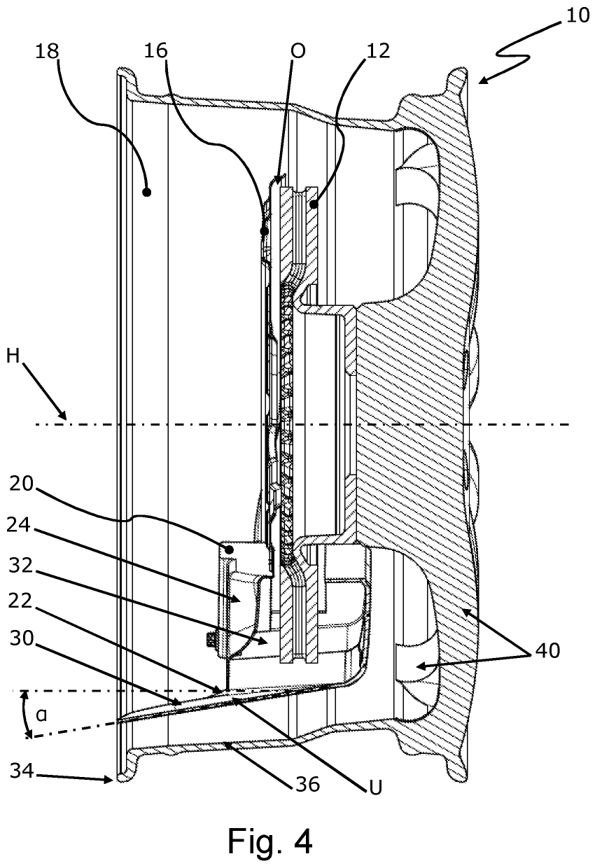

FIG. 4 shows a section IV-IV of the assembly 10 of FIG. 3. Under certain environmental conditions such as, for example, driving through rain, a carwash, wading or off-road, fluid can penetrate into the assembly 10 through the gaps between the brake disc 12 and the cover plate 16, between the brake disc 12 and the brake dust particle filter 20 as well as through various cutouts in the cover plate 16 and/or the brake dust particle filter 20. When such fluid subsequently remains in the assembly 10, this leads to undesirable sludge accumulation or clogging of the brake dust particle filter 20. The function of the brake dust particle filter 20 is impaired or even completely canceled. In order to ensure the function of the brake dust particle filter 20, it comprises at the lowermost point U of the housing 24, in particular of the housing interior 32, a drainage cutout 22. Fluid and/or solid bodies introduced into the assembly 10 can reach the lowermost point U of the housing 24, in particular of the housing interior 32, via the wall of the housing 24, the wall of the cover plate 16 and/or via the wall of the brake disc 12. The fluid is subsequently guided out of the housing 24 through the axially configured drainage cutout 22 that is embodied mostly parallel to the brake disc 12.

Guiding of the fluid through the housing interior 32 can be realized particularly effectively when the cover plate 16 is a component of the housing 24 of the brake dust particle filter 20. Due to a flow-optimized configuration of the housing interior 32, it is ensured that a quick drainage of the fluid is realized also across the largest distance between the uppermost point O, opposite the lowermost point U, and the lowermost point U.

The assembly 10 comprises a guide 30 that is positioned at the housing 24 externally at the drainage cutout 22. The guide 30 extends in this context primarily in axial direction, respectively, parallel to a brake disc rotation axis H, to the wheel rim inner edge 34 and comprises an incline α relative to a plane that is parallel to the horizontal H, respectively, to the brake disc rotation axis and extends through the lowermost point U. The incline α can be adapted in relation to the available installation space, in particular the space between brake dust particle filter 20 and wheel rim well 36. Moreover, there is the possibility of predetermining the flow velocity of the exiting fluid by means of the incline α. This is in particular important in connection with fluids of higher viscosity.

In the embodiment according to FIG. 4, the guide 30 is open in its circumferential direction, in particular groove-like. Depending on the application situation, the guide 30 can also be embodied closed in its circumferential direction, in particular tubular. Moreover, the cross section of the guide 30 can be of a round, rounded or angular configuration. In an advantageous embodiment, the guide 30 is embodied as one piece together with the housing 24 of the brake dust particle filter 20. This facilitates mounting as well as manufacture of the brake dust particle filter 20. Moreover, the guide 30 can be attached as a separate component at the brake dust particle filter 20 in order to enable a flexible conversion of the assembly 10 to a special application situation or in order to retrofit existing systems with brake dust particle filters 20 without guide 30 (see FIG. 1) in an inexpensive manner.

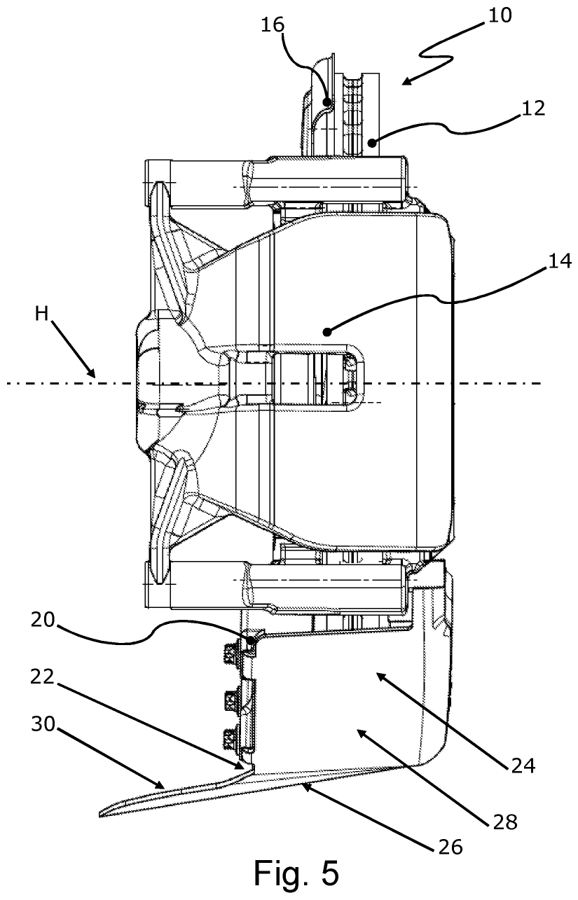

FIG. 5 shows a side view of the second embodiment of the assembly 10 with the brake disc 12, the brake caliper 14, and the brake dust particle filter 20. The brake dust particle filter 20 comprises the externally positioned, mostly axially extending guide 30, the radial circumferential side 28, and the housing bottom 26.

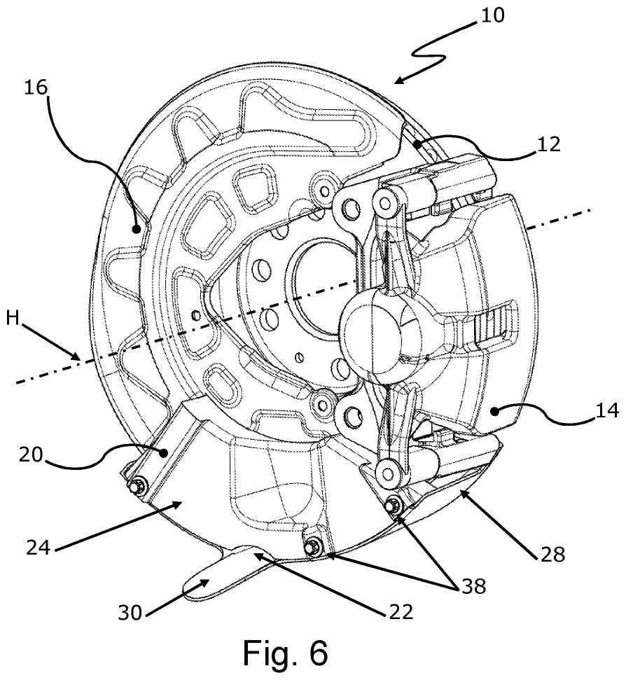

FIG. 6 shows the second embodiment of the assembly 10 with the brake disc 12, the brake caliper 14, the cover plate 16, and the brake dust particle filter 20 of FIG. 3. A guide 30 extending mostly in axial direction and mostly parallel to the horizontal H is arranged externally at the housing 24 of the brake dust particle filter 20.

The attachment of the brake dust particle filter 20 can be realized by means of at least one fastener 38, in particular a screw, on an immobile component, in particular the cover plate 16. The housing 24 in this context, depending on the application situation, can be of a one-part or multi-part configuration in order to meet special mounting or servicing requirements. In case of a multi-part embodiment of the housing 24, the connection of the partial housings is realized by means of the fasteners 38 or by specially provided fasteners (not illustrated) between the partial housings. In an advantageous manner, the partial housings are arranged movably relative to each other, in particular foldable, in order to ensure access to the housing interior 32 (see FIG. 4) in the mounting and/or servicing situation, for example, for exchange of the filter medium, without demounting the brake dust particle filter 20.

The housing 24 of the brake dust particle filter 20 comprises a circumferential side 28 which serves for forming filter cutouts (not shown). At the side of the housing 24 which is facing the housing interior 32 (see FIG. 4), a filter medium (not illustrated) is located for absorbing brake dust particles from the air flowing through the assembly 10 in the operation situation. During the operation, the brake dust in the form of particles is picked up by the air surrounding the brake disc 12 and entrained by it. In this context, the air flows first through the filter medium and subsequently through the filter cutout at the circumferential side 28 of the housing 24. In this context, the brake dust particles are separated in the filter medium.

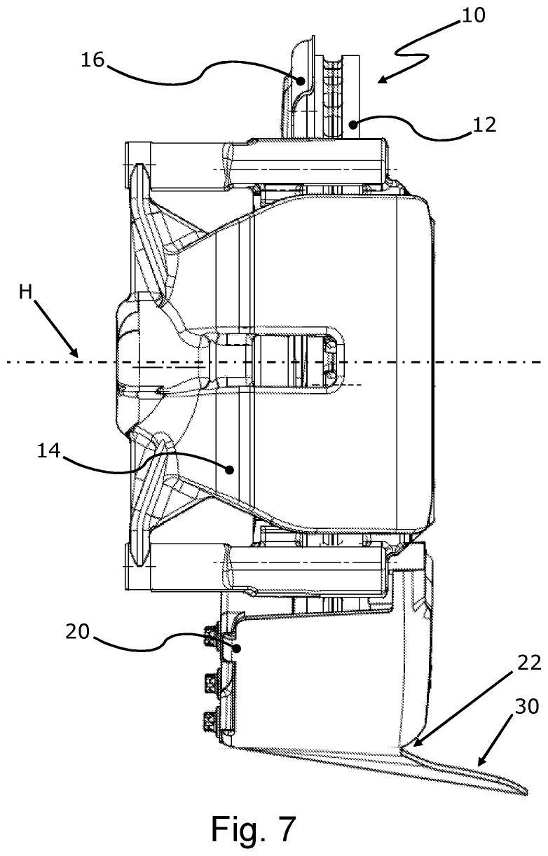

FIG. 7 shows the side view of a further embodiment of an assembly 10 wherein a brake dust particle filter 20 comprises a guide 30 which extends axially outwardly in the mounted state in the direction of the wheel rim spokes 40 (compare FIG. 4). With such an embodiment of the guide 30, the introduced fluid being discharged can be directed with a rinsing effect onto the wheel rim spokes 40 in order to clean off contaminations and deposits from the latter.

In reviewing all of the Figures of the drawing, a brake dust particle filter 20 as well as an assembly 10 with a brake disc 12, a brake caliper 14, in particular a cover plate 16, and the brake dust particle filter 20 is disclosed. The brake dust particle filter 20 in the mounted state is arranged in the bottom region of the brake disc 12 and comprises at its lowermost position U at the housing 24 a drainage cutout 22 in the form of an opening which serves for draining fluids from the housing 24 of the brake dust particle filter 20. The brake dust particle filter 20 can comprise in this context a guide 30 that guides the exiting fluid away from the brake dust particle filter 20 in the direction toward the wheel rim inner edge 34 and/or in the direction toward the wheel rim spokes 40.

### LIST OF REFERENCE CHARACTERS

10 assembly
12 brake disc
14 brake caliper
16 cover plate
18 wheel rim
20 brake dust particle filter
22 axial drainage cutout
24 housing
26 housing bottom
28 radial circumferential side of the housing 24
30 guide
32 housing interior
34 wheel rim inner edge
36 wheel rim well
38 fastener
40 wheel rim spokes
U lowermost point
O uppermost point
H horizontal and rotation axis of the brake disc 12
α incline of the guide 30 relative to the horizontal H
β incline of the housing bottom 26

What is claimed is:

1. A brake dust particle filter for an assembly with a brake disc, wherein the brake dust particle filter comprises:
a housing comprising a shape of a ring section and configured to at least partially surround the brake disc in a mounted state, wherein the housing comprises a housing interior, wherein the housing comprises or is comprised of a metal material;
wherein the housing interior comprises a lowermost point and comprises at the lowermost point an axially embodied drainage cutout configured to drain a fluid out of the housing interior;
wherein the housing comprises an outwardly positioned, mostly axially expanding guide arranged at the drainage cutout and configured to guide the fluid.

2. The brake dust particle filter according to claim 1, wherein the guide and the housing are formed together as one piece.

3. The brake dust particle filter according to claim 2, wherein the guide is closed in a circumferential direction thereof.

4. The brake dust particle filter according to claim 3, wherein the guide is tubular.

5. The brake dust particle filter according to claim 2, wherein the guide is open in a circumferential direction thereof.

6. The brake dust particle filter according to claim 5, wherein the guide is formed as a groove.

7. The brake dust particle filter according to claim 1, wherein the guide is inclined relative to the horizontal.

8. The brake dust particle filter according to claim 1, further comprising a filter medium, wherein the drainage cutout is covered at least partially by the filter medium.

9. The brake dust particle filter according to claim 8, wherein the drainage cutout is covered completely by the filter medium.

10. The brake dust particle filter according to claim 8, wherein the filter medium is a metal grid and/or a metal nonwoven.

11. The brake dust particle filter according to claim 1, wherein the housing is comprised of a multi-part configuration.

12. The brake dust particle filter according to claim 1, wherein the housing is comprised of a two-part configuration.

13. The brake dust particle filter according to claim 1, wherein, in an area surrounding the lowermost point of the housing interior, a wall of the housing is inclined in a direction toward the lowermost point of the housing interior.

14. The brake dust particle filter according to claim 13, wherein the wall of the housing is a radial circumferential side.

15. The brake dust particle filter according to claim 1, wherein the housing comprises a housing wall comprising at least one filter cutout with a filter medium.

16. The brake dust particle filter according to claim 15, wherein the housing wall is a circumferential side of the housing.

17. The brake dust particle filter according to claim 1, wherein a wall of the housing facing the housing interior comprises constructively provided depressions and/or elevations.

18. The brake dust particle filter according to claim 17, wherein the depressions are flow grooves and/or the elevations are guide ribs.

19. The brake dust particle filter according to claim 1, wherein a wall of the housing facing the housing interior comprises a surface coating configured to prevent fluid and/or solid bodies from adhering to the wall of the housing and/or to promote drainage of the fluid on the wall of the housing.

20. An assembly comprising:
a brake disc;
a brake caliper arranged at the brake disc;
a brake dust particle filter according to claim 1 arranged at least partially in a bottom region of the brake disc.

21. The assembly according to claim 20, further comprising a cover plate forming a part of the housing of the brake dust particle filter.

22. The assembly according to claim 20, further comprising a wheel rim, wherein the guide of the housing extends mostly axially to a wheel rim inner edge of the wheel rim and/or is oriented toward wheel rim spokes of the wheel rim to enable a targeted rinsing of the wheel rim spokes.
